(19) United States
(12) Patent Application Publication
(10) Pub. No.: US 2024/0417216 A1
(43) Pub. Date: Dec. 19, 2024

(54) MOBILE DEVICE, AND METHOD FOR CONTROL AN ELEVATOR

(71) Applicant: Inventio AG, Hergiswil (CH)

(72) Inventor: Ronny Kolb, Udligenswil (CH)

(21) Appl. No.: 18/701,265

(22) PCT Filed: Oct. 7, 2022
(86) PCT No.: PCT/EP2022/077884

§ 371 Date: Apr. 15, 2024

(30) Foreign Application Priority Data
Oct. 21, 2021 (EP) 21203959.8

(51) Int. Cl. B66B 5/00

(52) U.S. Cl. CPC B66B 5/0018; B66B 5/0087

(57) ABSTRACT

A mobile device, a control method, and an elevator controlled by the method or communicated with the mobile device are operated to facilitate maintenance or inspection work and enhance technician safety. The mobile device communicates with the elevator to select a task to be carried out for the elevator, determine the current position of the mobile device, and instruct a controller of the elevator for setting the elevator into a desired operation mode and for locating a car of the elevator in a desired car position in a shaft of the elevator, wherein the desired operation mode and the desired car position are defined by the mobile device according to the selected task and the current position of the mobile device.

### FIELD

The present invention relates particularly to a mobile device and a method for controlling an elevator. Furthermore, the invention relates to an elevator which can be controlled by the afore-mentioned method or can be communicated with such a mobile device.

### BACKGROUND

As elevators are applied for transporting passengers along vertical distances strict safety requirements have to be fulfilled. For keeping an elevator running safely the elevator occasionally requires maintenance or repair that is performed by service personnel, for example, to find, diagnose, and fix problems before they cause the elevator breakdown, malfunction or shutdown. During maintenance work service personnel need often go up on the roof of an elevator car or down to the pit in an elevator shaft which is potentially hazardous and could easily cause accidents and even fatalities to them. Concerning this, some elevator technical features must be checked by service personnel especially before beginning with a maintenance or an inspection work. Therefore, necessary safety precautions should be executed before carrying out an elevator maintenance task. On the other hand, it is necessary to set the elevator in its special operation mode, for example, a maintenance or inspection operation mode before a maintenance work begins. Additionally, the elevator car should be parked on a certain floor or at an appropriate location to make it easier and safer for service personnel to access the shaft of the elevator and operate the elevator.

In order to enable a technician to stop an elevator car at a desired place, EP3546411A1 discloses an elevator system which can be operated upon a command from a portable device indicating a desired floor on which the car is to be located. However, a problem might be that the desired floor is not the most suitable or the safest place for the technician or for a certain work to be carried out, especially when the technician is not yet competent. Even if the technician is sufficiently qualified, he/she would not always know exactly what has to be done, since the elevators and the safety procedures could be very complex and very different from one to another one.

### SUMMARY

Accordingly, there may exist a need for facilitating the maintenance or inspection work and enhancing personnel safety of an elevator. Such needs may be met with the subject-matter of the advantageous embodiments that are defined in the following specification.

According to the first aspect of the present invention, a mobile device is proposed for communicating with an elevator. Such a mobile device is capable of selecting a task to be carried out for the elevator, determining the current position of the mobile device, and instructing a controller of the elevator for setting the elevator into a desired operation mode and for locating a car of the elevator in a desired car position in a shaft of the elevator. The desired operation mode and the desired car position may be defined automatically by the mobile device according to the selected task and the current position of the mobile device. The current position means the current floor or the absolute position inside or outside of the shaft of the elevator where the mobile device currently is. The desired car position is a landing position of the car on a floor or a user-defined position in the shaft. The car can be parked in a position or on a floor where the user of the device, for example, desires to enter the shaft or the car.

After then, the elevator may automatically move the car according to the instruction of the mobile device to the desired car position and set the elevator into the desired operation mode. This means that the position of the car and the operation mode of the elevator desired can be matched better, safer, and more precise with the different selected task and the current position of the technician (user of the mobile device) so that it can provide more convenience (e.g., saving time) for the technician to access the shaft.

Generally, service personnel should undertake a checklist or finish some safety procedure steps before beginning or after completing maintenance or inspection of an elevator. The purpose of such safety procedures is to protect service personnel or other persons, for example, during maintenance work for elevators.

According to an embodiment of the present invention, before instructing the controller the mobile device may provide a request to perform a safety activity for a user of the mobile device when the task is selected, for example, if this task relates a safety of the elevator or of the service personnel. Helpful it is to provide a guidance for the user too on how to perform the required safety activity, for example, step by step. The required safety activity can be equivalent to a check-in or check-out process that service personnel shall follow for maintenance or inspection of an elevator. Providing the request and/or the guidance can be retained via a human-machine-interface (HMI) which can be a part of the mobile device or of the elevator. The HMI is preferably configurated as a graphical user interface (GUI) but could be also as a voice or language user interface.

According to a further embodiment of the present invention, the mobile device may request a confirmation that the safety activity is performed. The confirmation can be provided manually by the user via the mobile device or automatically by the mobile device when the safety activity has been finished.

According to an embodiment of the present invention, the mobile device may check the authenticity of the conformation, for example, concerning the shortest time or the maximal anticipatable time required to completely perform the safety activity. If the confirmation is provided earlier than the shortest time or later than the maximal anticipatable time, the mobile device won't send the afore-mentioned instruction to the controller of the elevator, and an alarm or a request of a new confirmation may be generated by the mobile device. The risk of an unanticipated operation promoted by an inadvertently or intendedly wrong answer of technicians thus can be prevented or reduced.

According to an embodiment of the present invention, the safety activity is predetermined depending on the task and saved in a memory unit which is inside or outside of the mobile device. If the memory unit is not a part of the mobile device, it may be a separate memory unit such as a USB flash drive or SD-card. The memory unit can be also a database communicating with the mobile device via local or public networks. To accomplish different tasks, different safety activities are predetermined accordingly.

The mobile device is a portable device like a smart mobile phone or a portable computer, etc. It is possible that the selection of a task, the determination of the current position, the instruction, and the providing the request and the confirmation can be executed by a mobile app (application software) installed in the mobile device.

According to the second aspect of the present invention, a method to control an elevator comprises following steps:
selecting a task by a mobile device that is to be carried out for the elevator,
determining the current position of the mobile device,
instructing a controller of the elevator by the mobile device to set the elevator into a desired operation mode and to locate a car of this elevator in a desired car position in a shaft of the elevator, wherein the desired operation mode and the desired car position are defined automatically by the mobile device according to the selected task and the current position of the mobile device.

With respect of the second aspect of the present invention, before instructing the controller a request to perform a safety activity is provided by the mobile device for its user when the task is selected. A confirmation can be requested by the mobile device that the safety activity is performed. The authenticity of the conformation is to be checked by the mobile device. The safety activity is predetermined depending on the task and saved in a memory unit.

According to the third aspect of the present invention, an elevator is proposed which is capable of responding to an afore-mentioned mobile device or capable of executing an afore-mentioned method.

By individually matching a desired operation mode and a desired car position to a selected task, by reminding technicians of paying attention to certain required safety activities, by providing guidance/help information, and/or by requiring a confirmation of the execution of the safety procedures, the safety of the elevator may be enhanced.

It shall be noted that possible features and advantages of embodiments of the invention are described herein partly with respect to a mobile device for communicating with an elevator, partly with respect to a method to control an elevator, and partly with respect to an elevator responding to and/or executing an instruction from such a mobile device. One skilled in the art will recognize that the features may be suitably transferred from one embodiment to another, and features may be modified, adapted, combined and/or replaced, etc., in order to come to further embodiments of the invention. Ideas underlying embodiments of the present invention may be interpreted as being based, inter alia, and without restricting the scope of the invention, on the following observations and recognitions.

In the following, advantageous embodiments of the invention will be described regarding the enclosed drawings. However, neither the drawings nor the description shall be interpreted as limiting the invention.

### DESCRIPTION OF THE DRAWINGS

FIG. 1 shows a schematic diagram of an elevator and a mobile device according to an embodiment of the present invention, and

FIG. 2 shows a flow diagram of a method according to an embodiment of the present invention.

### DETAILED DESCRIPTION

For the purpose of illustration, the following description sets forth details regarding a mobile device 5, a method that could be performed using the technology of the invention, and an elevator 1 being able to communicate with such a mobile device 5. The figures are only schematic and not to scale. The same reference signs refer to the same or similar features.

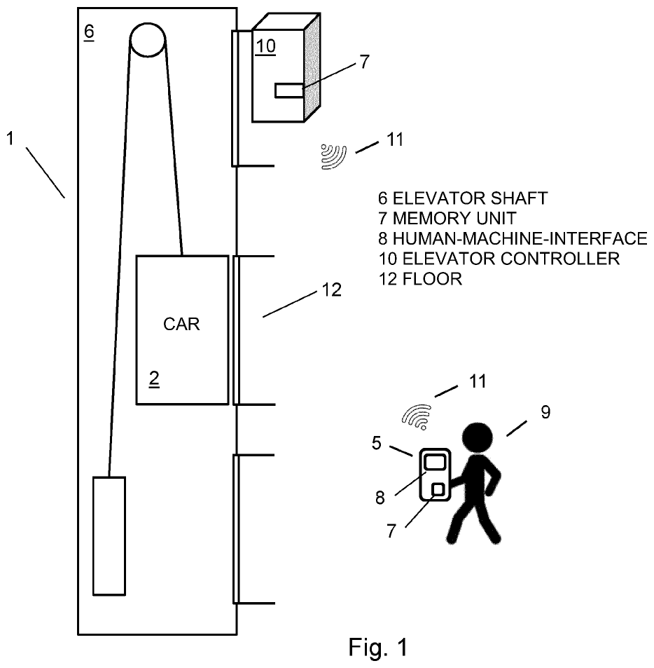

FIG. 1 shows an elevator 1 and a mobile device 5. The elevator 1 comprises a car 2 which is movable vertically in an elevator shaft 6 and may stop at different floors 12. An elevator controller 10 is provided which can be also as a so-called main controller of the elevator 1 responsible for coordinating all aspects of elevator operating.

The mobile device 5 assigned to a technician 9 who is going to start a maintenance work as a task for the elevator 1. A specific app installed in the mobile device 5 may establish a suitable wireless or wired communication 11 with the controller 10 and/or with other networks. According to the task to be performed, the mobile device 5 will determine its current position and then instruct the controller 10 to set the elevator 1 into a desired operation mode and to locate the car 2 of the elevator 1 in a desired car position in the shaft 6. According to the selected task and the current position of the mobile device 5, the desired operation mode and the desired car position are defined automatically by the mobile device 5. The desired car position can be a landing position of the car 2 on a floor 12 or an any defined position in the shaft 6.

Moreover, when the selected task is a safety-related task, the technician 9 at first has to accomplish certain safety activities. The safety activities may include safety procedure steps or a checklist that service personnel shall follow. The mobile device 5 comprises a human-machine-interface (HMI) 8 for providing a request and a guidance to perform a safety activity for the technician 9 when he/she has selected the task. The HMI 8 is preferably a graphical user interface (GUI). The HMI 8 could be also a voice or language user interface. If the request is outputted by a loudspeaker of the mobile device 5 as spoken language, the technician 9 may give his/her answer also in spoken language through a microphone of the mobile device 5.

The safety activity can be predetermined depending on the task and saved in a memory unit 7 such as a USB flash drive or SD-card which is inside or outside of the mobile device 5. The memory unit 7 can be also a database communicating with the mobile device 5 via local or public networks. For different tasks, different safety activities are predetermined and saved accordingly.

The mobile device 5 may also request the technician 9 for a confirmation that the safety activity is performed. The confirmation can be provided manually by the technician 9 via the mobile device 5 or automatically by the mobile device 5 when the safety activity has been finished. Furthermore, the mobile device 5 will check the authenticity of this conformation according to a reasonable length of time in which the required safety activity needs to be completely executed. The reasonable length of time concerns a time period between a predetermined shortest time and a predetermined maximal anticipatable time. If the confirmation is provided earlier than the shortest time or later than the maximal anticipatable time, the mobile device 5 will generate an alarm or request a new confirmation, as the last confirmation might have been caused by a malfunction or an unintentional input by the technician 9.

If the confirmation is accepted, the mobile device 5 will instruct the controller 10 to switch the elevator 1 into the desired operation mode and to locate the car 2 in the desired car position. Responding to this instruction, the controller 10 will drive the car 2 accordingly to the desired car position and set the elevator 1 into the desired operation mode so that it will provide more convenience (e.g., saving time) for the technician 9 to access the shaft 6 and operate the elevator 1.

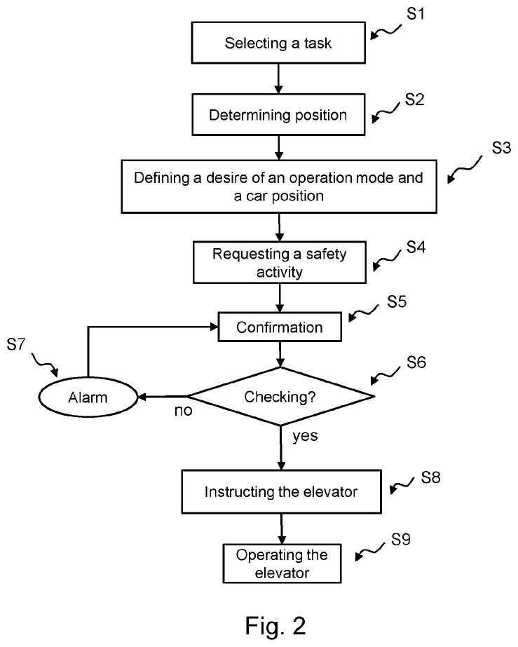

FIG. 2 shows a method to control an elevator 1 for starting a task by instruction of a mobile device 5. Particularly, this method includes the following steps:
S1: A technician 9 selects a task via a mobile device 5, wherein a maintenance work is defined as the task to be accomplished,
S2: Determining the current position of the mobile device 5,
S3: According to the selected task and the determined current position, defining a desired operation mode of the elevator 1 to be switched and a desired car position where the elevator car 2 is to be located,
S4: Requesting the technician 9 to perform a safety activity according to the selected task, for example, to go through a checklist,
S5: Requesting the technician 9 to confirm that he/she has completed the safety activity,
S6: Checking the authenticity of the conformation, for example, whether this confirmation is provided between the shortest time and the maximal anticipatable time required to perform the safety activity,
S7: Generating an alarm or requesting a new confirmation, if the confirmation is not accepted,
S8: Instructing the controller 10 of the elevator 1 about the desired operation mode and the desired car position, if the confirmation has passed the check, and
S9: Responding to the instruction, the elevator 1 is switched into the desired operation mode, and the car 2 of the elevator 1 is located in the desired car position in a shaft 6 of the elevator 1.

Finally, it should be noted that the term “comprising” does not exclude other elements or steps, and the “a” or “an” does not exclude a plurality. Also, elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-11. (canceled)

12. A mobile device for communicating with an elevator, the mobile device comprising:
an application installed in the mobile device that when executed by the mobile device causes the mobile device to:
select a task to be carried out for the elevator;
determine a current position of the mobile device; and
instruct a controller of the elevator to set the elevator into a desired operation mode and to locate a car of the elevator in a desired car position in a shaft of the elevator, wherein the desired operation mode and the desired car position are defined by the mobile device according to the selected task and the current position of the mobile device.

13. The mobile device according to claim 12 wherein before instructing the controller the mobile device provides a request to perform a safety activity to a user of the mobile device when the selected task is selected.

14. The mobile device according to claim 13 wherein the mobile device requests a confirmation that the safety activity is performed.

15. The mobile device according to claim 14 wherein the mobile device checks an authenticity of the confirmation.

16. The mobile device according to claim 12 wherein the safety activity is predetermined depending on the selected task and is saved in a memory unit that is inside or outside of the mobile device.

17. An elevator comprising a controller adapted to communicate with the mobile device according to claim 12.

18. A method to control an elevator, the method comprising following steps:
selecting a task by a mobile device, wherein the selected task is to be carried out for the elevator;
determining a current position of the mobile device; and
instructing a controller of the elevator by the mobile device to set the elevator into a desired operation mode and to locate a car of the elevator in a desired car position in a shaft of the elevator, wherein the desired operation mode and the desired car position are defined by the mobile device according to the selected task and the current position of the mobile device.

19. The method according to claim 18 wherein before instructing the controller the mobile device requests a user of the mobile device to perform a safety activity when the task is selected.

20. The method according to claim 19 wherein the mobile device requests a confirmation that the safety activity is performed.

21. The method according to claim 20 wherein the mobile device checks an authenticity of the conformation.

22. The method according to claim 19 wherein the safety activity is predetermined depending on the selected task and is saved in a memory unit.

23. An elevator comprising a controller adapted to communicate with a mobile device to perform the method according to claim 18.
